(19) United States
(12) Patent Application Publication
(10) Pub. No.: US 2001/0030625 A1
(43) Pub. Date: Oct. 18, 2001

(54) Local clock-referenced DTOA geolocation system with wireless infrastructure

(76) Inventors: Daniel T. Doles, Saratoga, CA (US); Timothy C. Harrington, Los Gatos, CA (US); Donald K. Belcher, Rogersville, TN (US); Robert W. Boyd, Eidson, TN (US); Michael A. Wohl, Rogersville, TN (US)

Correspondence Address: CHRISTOPHER F. REGAN, ESQUIRE, ALLEN, DYER, DOPPELT, MILBRATH & GILCHRIST, P.A., P. O. Box 3791, Orlando, FL, 32802-3791, US

(21) Appl. No.: 09/756,625

(22) Filed: Jan. 8, 2001

Related U.S. Application Data
(63) Continuation-in-part of application No. 09/649,646, filed on Aug. 29, 2000.
(60) Provisional application No. 60/175,641, filed on Jan. 12, 2000.

(51) Int. Cl. G01S 1/24

(52) U.S. Cl. 342/387; 342/465

(57) ABSTRACT

An object tracking system for locating radio-tagged objects has a plurality tag transmission readers that detect tag transmissions, and generate time-of-arrival output signals representative of the time-of-arrival of first-to-arrive tag transmissions on the basis of clock signals generated by local clock generators at the tag reader sites. The tag reader sites may transmit time-of-arrival signals to an object location processor by way of a wireless local area network. Measurements made on transmissions from a fixed position reference tag are used to update a reader clock offset database employed by the processor to maintain the reader clocks effectively time aligned.

### CROSS-REFERENCE TO RELATED APPLICATION

The present application claims the benefit of co-pending U.S. Provisional Patent Application Ser. No. 60/175,641, by D. Doles et al, filed Jan. 12, 2000, entitled: “Geolocation System With Wireless Infrastructure,” and is a continuation-in-part of co-pending U.S. Non-Provisional Patent Application Ser. No. 09/649,646, filed Aug. 29, 2000, by Robert W. Boyd et al, entitled: “Multi-Lateration System with Automatic Cable Calibration and Error Removal,” (hereinafter referred to as the '646 application), each application being assigned to the assignee of the present application and the disclosures of which are incorporated herein.

### FIELD OF THE INVENTION

The present invention relates in general to object tracking systems that identify locations of radio-tagged objects, and is particularly directed to a local or internal clock-referenced differential-time-of arrival (DTOA) geolocation system, that uses a wireless infrastructure to communicate between multiple reader sites, each of which contains its own local time base reference or clock, and a (triangulation geometry-based) tagged object location processor. In addition, the invention employs TOA measurements made on emissions from a fixed position reference tag of the type employed in the '646 application, to update a reader clock offset database used to effectively maintain the reader clocks in mutual ‘synchronization’.

### BACKGROUND OF THE INVENTION

As described in the introductory portion of the above-referenced '646 application, the U.S. patent to Heller, U.S. Pat. No. 5,119,104, entitled: “Location System Adapted for Use in Multipath Environments” describes a motion-based system for tracking objects that are ‘tagged’ with micro-miniaturized radio transmitters. Until triggered by motion sensors, the transmitters are in a quiescent mode. However, when the object to which the transmitters are ‘tagged’ is moved, a motion sensor causes its tag transmitter to emit an RF signal encoded with the identification of the tag, so that as long as the object is moving, its tag will transmit. Using multi-lateration receivers distributed in the monitored area of interest, and referenced to a time base for time-of-arrival processing, the location of a radio tag and thereby its moving object can be tracked, up to the point where it is at rest. The tag radio then reverts to quiescent mode, with transmission disabled until the object is again moved.

A principal shortcoming of such a motion-dependent object tracking system is the fact that, in addition to being dependent up the object being moved and contrary to what the patent alleges, the patented system does not effectively solve the problem of multipath inputs to its tracking receiver subsystem. This latter shortcoming is due to the fact that it employs relatively simple amplitude detection receivers, which operate on the assumption that the strongest signal will be the first-to-arrive signal. This means that the Heller approach will erroneously use a later arriving, large amplitude, multipath signal, rather than a relatively weak, but first-to-arrive signal, that has travelled to the receiver in a direct path through an attenuating medium.

A further deficiency of the system proposed in the Heller patent is the fact that it is not concerned with the more fundamental problem of asset management. Asset management not only addresses the need to locate and track processed components in the course of their travel through a manufacturing and assembly sequence, but is also concerned with the more general problem of component and equipment inventory control, where continuous knowledge of the whereabouts of any and all assets of a business, factory, educational, military or recreational facility, and the like, is desired and/or required. An asset management system may also benefit from status information that can be provided to the tag, by means of an auxiliary sensor associated with the tag—something not addressed by the Heller scheme.

Advantageously, the deficiencies of conventional object location systems, including the system proposed in the above-referenced Heller patent, are successfully remedied by tagged object geolocation systems of the type described in the U.S. patents to Belcher et al, U.S. Pat. Nos. 5,920,287, and 5,995,046, assigned to the assignee of the present application and the disclosures of which are incorporated herein, and having an overall architecture as diagrammatically illustrated in FIG. 1.

As shown therein, this improved system includes a plurality of tag emission readers 10 that are geographically distributed within and/or around an asset management environment 12. This environment contains a plurality of objects/assets 14, whose locations are to be monitored on a continuous basis and reported to an asset management data base 20, that is accessible by way of a computer workstation or personal computer 26. Each of the tag emission readers 10 monitors the asset management environment for emissions from one or more tags 16 affixed to the objects 14. Each tag 16 contains a transmitter that is configured to repeatedly transmit or ‘blink’ a very short duration, wideband (spread spectrum) pulse of RF energy, encoded with the identification of its associated object and other information stored in a tag memory.

The bursts of RF energy emitted by the tags are monitored by the readers 10 installed at fixed (precisely geographically known), relatively unobtrusive locations within and/or around the perimeter of the environment being monitored, such as doorway jams, ceiling support structures, and the like. Each tag reader 10 is coupled to an associated reader output processor of an RF processing system 24. The reader processor correlates the spread spectrum signals received from a tag with a set of spread spectrum reference signal patterns, and thereby determines which spread spectrum signals received by the reader is a first-to-arrive spread spectrum signal burst transmitted from the tag.

The first-to-arrive signals extracted by the reader output processors from the signals supplied from the tag emission readers 10 are then forwarded to an object location processor within the processing system 24. The object location processor performs time-of-arrival differentiation of the detected first-to-arrive transmissions, and thereby locates (within a prescribed spatial resolution (e.g., on the order of ten feet) the tagged object of interest.

To mitigate against the potential for fades and nulls resulting from multipath signals destructively combining at one or more readers, the geolocation system described in the above-referenced Patents to Belcher et al may be augmented to employ a spatial diversity-based receiver-processing path architecture, in which plural (e.g., two) readers are installed at each monitoring location, and associated signal processing paths therefor are coupled therefrom to the geometry (triangulation) processor.

As an additional modification, a plurality of auxiliary ‘phased array’ signal processing paths may be employed to address the situation in a multipath environment where a relatively ‘early’ signal may be canceled by an equal and opposite signal arriving from a different direction. Advantage is taken of the array factor of a plurality of antennas to provide a reasonable probability of effectively ignoring the destructively interfering energy. The phased array provides each reader site with the ability to differentiate between received signals, by using the ‘pattern’ or spatial distribution of gain to receive one incoming signal and ignore the other.

Irrespective of the architecture of such a geolocation system, a typical tagged object monitoring installation will customarily contain varying lengths of cable plant (such as RF coax) connecting the readers to a signal processing subsystem separate from the readers. As described above, the signal processing subsystem processes the signals received by and forwarded to it by the readers, in order to determine the various times of arrival at the distributed tag transmission reader locations of a transmission from the tag.

Because the lengths of cable and therefore the transport delays between the tag transmission readers and the processor are known, the processor can readily determine the times of arrival at the readers of the various first-to-arrive signals transmitted by the tag, based upon the signals which it receives from the readers. Namely, reader time-of-arrival is premised upon a time base reference employed at the processor, and extrapolating detection times back to the readers on the basis of the cable plant transport delay, in order to determine when the transmissions arrived at the readers. These extrapolated times-of-arrival at the readers are then processed by means of time-of-arrival differentiation, to geolocate the tagged object of interest (e.g., triangulate the tag relative to the locations of the tag transmission readers whose locations are fixed and known).

However, there is the problem that the transport delays through various sections of cable plant connecting the readers to the processor can be expected to vary. In some cases, the cables may be very short and located indoors. In other cases (including the same site), the cables may be very long and located outdoors (which also means that they must be buried). Namely, the physical environment through which any cable is routed between its reader and the processor may encounter a set of ambient conditions that is different from those of cable sections for other readers. This differential cable length and environment parameter situation creates the possibility of system timing errors, associated with the cable delays drifting due to weather or other effects (e.g., age, humidity, physical stretching, etc.), resulting in geolocation errors.

The invention disclosed in the '646 application, shown diagrammatically in FIG. 2, effectively obviates this cable plant-based signal transport delay problem by placing one or more ‘reference’ tags 16R, whose geolocations (like those of the tag emission readers 10) are fixed and precisely known, within the monitored environment 12 containing the objects 14 to be tracked. Using a background calibration routine that is exercised at a relatively low cycle rate relative to the blink, rate of a tagged object, emissions from the reference tags are detected by the readers 10, and first-to-arrive signals are processed by the geolocation processor 24 to calculate the location of the reference tag.

The calculated geolocation of a reference tag is then compared with its actual (known) location, which may be stored in a calibration database, or stored in memory on board the reference tag and included as part of the information transmitted by the reference tag and received by transmission readers. Any offset between the two reference tag geolocation values (measured and actual) is used by the geolocation processor to an associate data base or look-up table of time delay values for the various (cable plant) signal transport paths from the readers and thereby track out associated timing errors.

Now even though the above-described cable plant-based delay problem can be effectively obviated by the invention detailed in the '646 application, the fact that time-of-arrival processing takes place at the downstream processor, where a common timing reference is available, means that it is necessary to provide a high fidelity signal transport path between each of the readers and the processor over which to convey the signals received by the readers to the processor. Such a signal transport path is customarily implemented by a cable plant whose installation can involve substantial cost, particularly in an outdoor environment, where the cable must be buried in below-ground trenches.

### SUMMARY OF THE INVENTION

In accordance with the present invention, this problem is effectively circumvented by removing the timing reference from the processor and placing it at the reader. This allows each tag transmission reader to perform its own time-of-arrival (TOA) measurement on an identified first-to-arrive tag emission, as referenced to a reasonably stable internal or local clock at the reader proper. Performing time-of-arrival (TOA) measurements using local time bases (internal clocks) at the readers, rather than using a common time base at the downstream processor, not only reduces the criticality of employing high fidelity signal transport links between the readers and the processing subsystem, but also means that the measurement data derived by the readers need not be transported to the processor in real time or in any particular format.

For example, the TOA measurement data derived by the readers may be forwarded over a relatively low bandwidth return link (such as a readily available wireless local area network) to the (triangulation geometry-based) location processor. The use of a readily available communication infrastructure, such as a wireless local area network link, also avoids the costly exercise of having to install (including burying) sections of cable plant between each of the receivers and the location processor. The location processor executes a standard multi-lateration algorithm, that relies upon the time-of-arrival representative clock code outputs supplied from the readers to compute the location of an emitting tag.

Of course, in order for each tag transmission reader to use its own local clock as a time base reference, it is necessary that all of the readers' local clocks be maintained effectively continuously synchronized, as the tags will be transmitting randomly and there must always be an available time base reference with which to mark all reader times of arrival. Unfortunately, even if simultaneously triggered at system start-up, the receiver sites, internal clocks can be expected to slowly drift apart (in a timewise sense); if not corrected, this drift will introduce error into the differential time-of-arrival (DTOA)-based measurements carried out by the location processor.

To successfully remedy this potential problem, the location processor maintains a reader clock calibration or offset code database. This clock offset database stores a table of reader clock offsets, employed by the location processor to correct for any drifts or offsets in the various reader clocks ‘locally’ installed at the receiver sites. These reader clock offset codes are periodically updated in accordance with the differential processing of time-of-arrival measurements performed by the tag readers for emissions from a fixed, known reference tag of the type employed in the system described in the '646 application.

Since any drifts in the tag readers' internal clocks during the time between reference tag emissions can be expected to occur at a relatively slow rate, the reference tags are configured to blink less frequently than the object tags. This effectively extends the battery life of the reference tags relative to that of the object tags, and also allows the clock calibration to be performed as a relatively non-intrusive background routine. To maintain accuracy in the geolocation calculation, the reader clocks should not exhibit more than a relatively slow drift during the interval between transmissions from the reference tag. Also, the time interval between calibration transmissions from the reference tag should be as long as practically possible, in order to reduce the actual on-the-air time of the reference tag, and minimize communications load. With the availability of micro ovens, and SC-cut crystals, very low clock drift rates can be achieved over a several second time frame.

Advantages of the invention include installation simplicity and cost, as it obviates the need to install a cable plant infrastructure and having to use costly high precision timing standards. Such high precision timing standards are customarily employed in conventional DTOA systems that employ multi-lateration techniques. These systems rely on the distribution of a high precision timing standard via either high bandwidth cable or the inclusion of highly precise global positioning system (GPS) receivers at each monitoring site, to ensure all receive sites are in time synchronization—a necessary condition for performing the time difference calculation.

### BRIEF DESCRIPTION OF THE DRAWINGS

FIG. 1 diagrammatically illustrates the general architecture of a tagged object tracking and location system detailed in the U.S. patents to Belcher et al, U.S. Pat. Nos. 5,920,287, and 5,995,046;

FIG. 2 is a reduced complexity depiction of a radio tag-based geolocation system architecture of the type described above with reference to FIG. 1, containing a ‘reference’ tag whose geographic coordinates are precisely known, as detailed in the '646 application;

FIG. 3 is a reduced complexity diagram of a geolocation system in accordance with the invention; and

FIG. 4 is a flow chart of the steps of a receiver clock drift calibration routine that may be employed by the location processor in the system of FIG. 3.

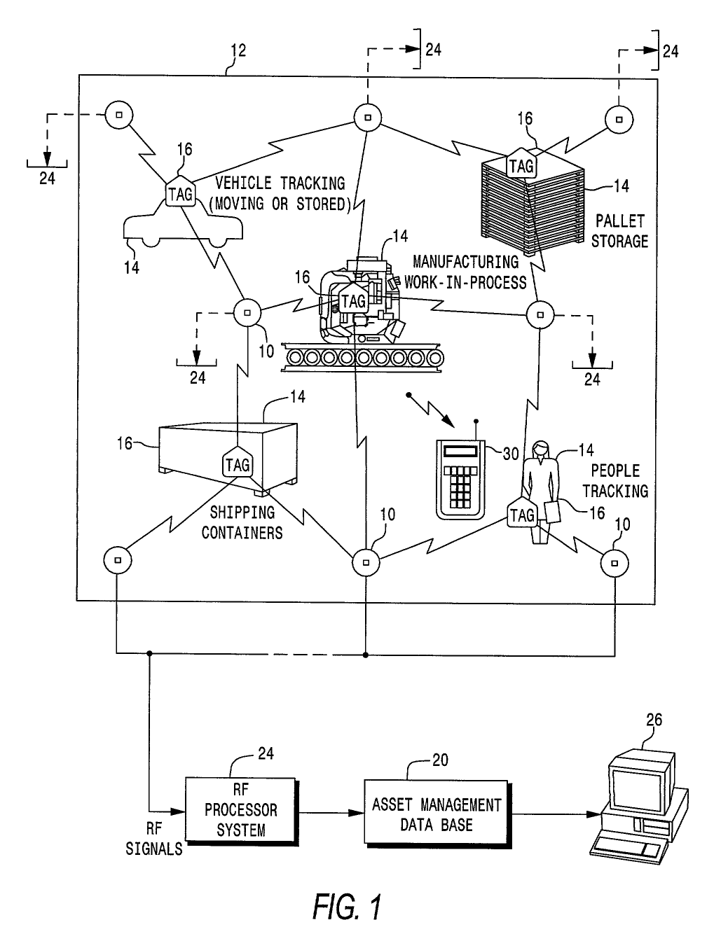

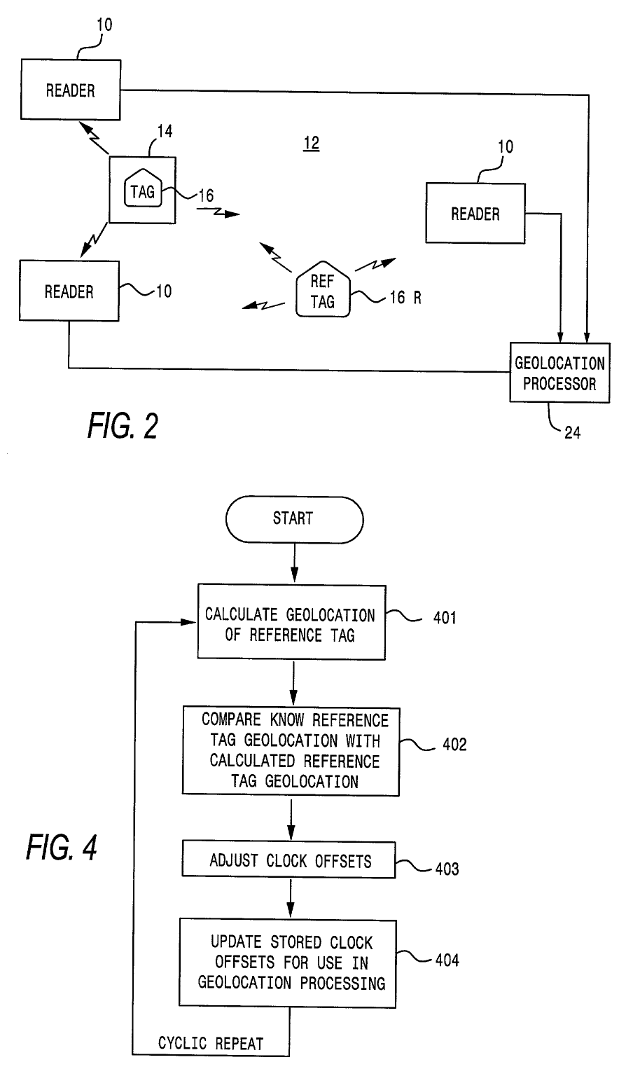

### DETAILED DESCRIPTION

Before detailing the local clock-referenced, DTOA-based, wireless infrastructure-configured geolocation system of the invention, it should be observed that the present invention resides primarily in a number of augmentations to a geolocation system of the type described in the above-referenced Belcher et al Patents and '646 application. A first augmentation involves configuring each tag reader to perform a time-of-arrival (TOA) measurement on a tag emission, referenced to a local clock at the reader. By referencing a time-of-arrival (DTOA) measurement to a local reader clock, the complexity of the data derived by the reader is substantially reduced. This allows, as a second augmentation, the use of a relatively convenient return data link (such as a wireless link (e.g., wireless local area network (WLAN)) to the location processor.

In order to maintain the tag readers' local clocks in mutual synchronization that ensures accurate differential time of arrival based location measurements, the location processor maintains a reader clock calibration database, which contains a table of periodically recalibrated reader clock offsets that correct for drifts in the various reader clocks. These reader clock offsets are updated by processing time-of-arrival measurements performed by the tag readers on periodic calibration transmissions from a reference tag of the type employed in the system described in the '646 application.

The invention is readily implemented in an arrangement of conventional communication circuits and associated digital signal processing components and attendant supervisory control circuitry therefor, that controls the operations of such circuits and components. The configuration of such circuits components and the manner in which they interface with other communication system equipment have, accordingly, been illustrated in readily understandable block diagram format, depicting details that are pertinent to the present invention, so as not to obscure the present disclosure with details which will be readily apparent to those skilled in the art having the benefit of the description herein. Thus, the block diagram illustrations are primarily intended to show the major components of a tag-based geolocation system in a convenient functional grouping, whereby the present invention may be more readily understood.

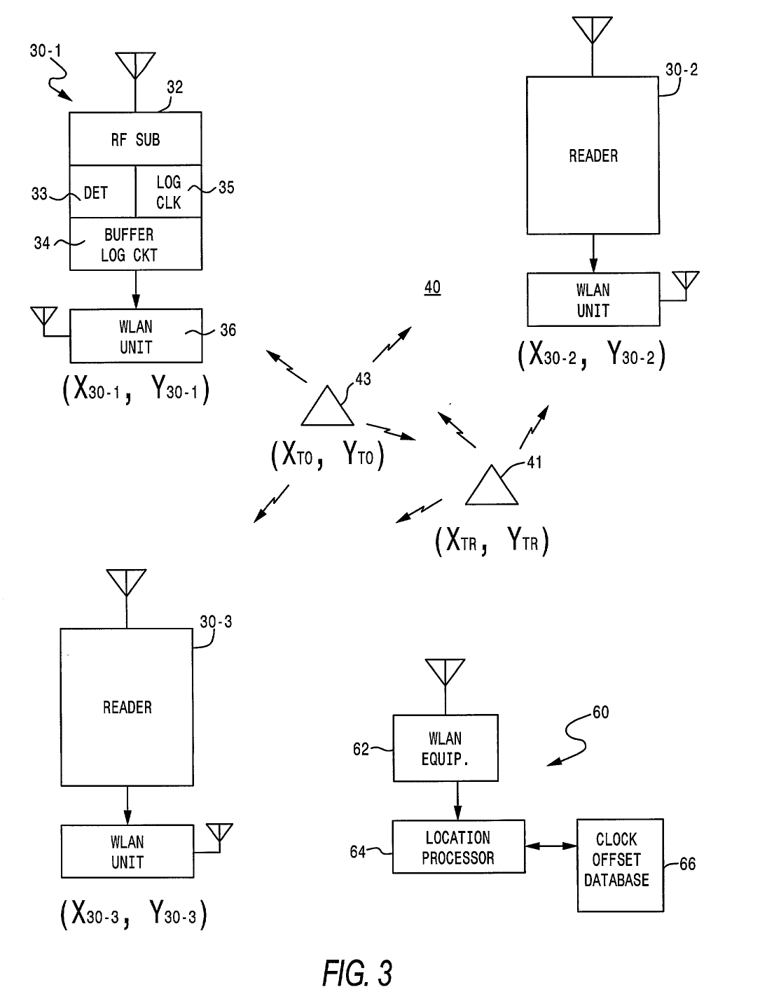

Attention is now directed to FIG. 3, which is a reduced complexity diagram of a geolocation system in accordance with the invention, having three geographically distributed tag reader or receiver sites 30-1, 30-2 and 30-3, whose respective geographical coordinates (x₃₀₋₁, y₃₀₋₁), (x₃₀₋₂, y₃₀₋₂) (x₃₀₋₃, y₃₀₋₃) are known precisely, and which are employed to monitor an environment 40 containing a number of tagged objects whose locations are to be determined. The monitored environment 40 contains both a fixed reference tag 41, whose geographical coordinates (x_{TR}, y_{TR}) are precisely known, and a plurality of object tags, one of which is shown at 43, the locations (x_{TO}, y_{TO}) of which are to be determined.

Although only three receiver sites are shown in FIG. 3, it is to be observed that the number illustrated is merely for purposes of providing a non-limiting example, and reducing the complexity of the diagram; the invention may be applied to any plurality of receiver sites that provide for geometric-based (e.g., triangulation) location determination. To this end, the receiver sites 30 are distributed relative to the monitored environment 40, such that a tag reader installed at a receiver site can ‘see’ or receive transmissions from both the reference and object tags.

Each of the tags 41 and 43 repetitively transmits a signal whose properties allow a respective receiver site's tag reader to determine the time-of-arrival of the signals with respect to an internal time clock of an associated timing generator 31. For this purpose, the tags and the tag readers may be configured as described in the Belcher et al Patents and the '646 application, referenced above. Coupled with the front end of each tag reader is an associated RF subsystem 32 including antenna, downconversion and digitizing components, the output of which is coupled to an associated first arrival detector unit 33, whose output corresponds to the first-to-arrive emission from a tag.

As pointed out briefly above, the time of occurrence of this first-to-arrive signal, as detected by the detector unit 33, is captured by a buffer logic circuit 34 in terms of the precision of an internal ‘local’ time clock source of the receiver site's timing generator. This captured clock time provides an output code representative of the value of the receiver's internal clock at the time the tag emission is detected. This local (tag emission arrival time-representative) clock time code is coupled to associated transmission equipment 36 for transmission to a location processor site 60, which includes associated link transmission equipment 62 coupled to a (triangulation geometry-based) location processing subsystem 64.

The reader-to-processor link preferably comprises a wireless link, such as a wireless local area network (WLAN). Alternatively, it may employ any other readily available means of connectivity, such as ‘ethernet’, phone line, etc., that avoids the costly exercise of having to install sections of cable plant between each of the receivers 30 and the location processor site 60. As in the system described in the '646 application, the location processing subsystem 64 preferably executes a standard multi-lateration algorithm, that relies upon the time-of-arrival representative clock code outputs supplied from at least three readers (e.g., readers 30-1, 30-2 and 30-3 in the illustrated embodiment) to compute the location of an emitting tag.

Over time, it can be expected that the receiver sites' internal clock generators will slowly drift apart with respect to each other. If not corrected, this drift would introduce error into the differential time-of-arrival (DTOA)-based measurements carried out by the location processor. To correct for this potential problem, the periodic emissions from the reference tag 41, whose geographical coordinates are precisely known, are monitored and processed in a manner similar to that described in the '646 application, to recalibrate or ‘resynchronize’ a set of clock offset codes that are stored in a reader clock calibration database 66 and used by the location processor 64, to correct for drifts in the various reader clocks installed at the receiver sites.

Similar to the system described in the '646 application, the reference tag 41 may employ the same type of blinking transmitter as those employed by the object tags 43 to be tracked, so that its detected RF signature will conform with those of the object tags whose locations are unknown. Since the geolocation of the reference tag 41 and also those of the tag readers 30 are precisely known, the time delay of a radio transmission from the reference tag 41 to each receiver site 30 is known because the exact straight-line distance is known and the speed of light is known.

Consequently, any difference in the calculated position (x_{CR}, y_{CR}) of a reference tag 41, as determined by the location processor 64, and the actual coordinates (x_{TR}, y_{TR}) of the reference tag 41, which are precisely known a priori, are indicative of timing differences or offsets in the local clocks employed by the tag readers 30 to generate the time of arrival information of a detected reference tag emission. Since any such drifting in the tag readers' internal clocks (during the time between reference tag emissions) can be expected to occur at a relatively slow rate, the reference tags 41 may be configured to blink less frequently than the object tags 43. This effectively extends the battery life of the reference tags relative to that of the object tags, and also allows the clock table calibration to be performed as a relatively non-intrusive background routine.

FIG. 4 is a flow chart of the steps of a receiver clock calibration routine employed by the location processor, that is used to update reader clock offset values employed to correct for the lack of actual time alignment among the reader clocks, and thereby effectively repeatedly ‘resynchronize’ the receiver clocks, so that time-of-arrival clock codes produced by the tag readers may be accurately employed in tagged object geolocation calculations. At step 401 of the routine, using the internal clock-referenced codes supplied by the each of the tag readers as a result of their detecting first-to-arrive signals associated with a transmission burst from the reference tag 41, the object location processor 64 proceeds to calculate the location of the reference tag 41. Like the location calculation for a object tag 43, the location calculation for the reference tag 41 will include the use of the set of adjustable reader clock offsets (principally due to differences in drifts of the reader clocks) stored in memory.

Next, in step 402, the known actual geolocation of the reference tag 41 (previously stored in memory) is compared with its calculated location. The precisely known geolocation of a reference tag 41 may be stored in memory employed by the object location processor 60 and/or it may be loaded into memory on board the reference tag 41 and included as part of the information contained in a reference tag transmission burst. In step 403, any difference in the two values (true reference tag location and calculated reference tag location) is used by the location processor to modify the set of stored clock offsets that are used in each geolocation calculation. As a non-limiting example, the offset modification may include a fractional scaling of the stored offset values in proportion to the magnitude of the error between the calculated and known locations of the reference tag, so that over (periodically) repeated reference tag-based clock offset calibration cycles, the clock offset error may asymptotically self-minimize.

In step 404, the currently stored reader clock offset values are replaced with updated reader clock offset values, to be used in the course of ongoing tagged object geolocation calculations, prior to the next reference tag-based calibration cycle. During the time interval between calibration transmissions from the reference tag 41, random transmissions from one or more object tags 43 will be received in a manner that allows the location processor 64 to employ differential time-of-arrival (DTOA) based trilateration to compute the location of the object tag. This process has sufficient accuracy so long as any drift in the reader clock generators is not excessive.

For example, if any two clocks drift apart by one billionth of a second (one nanosecond), the computed location would be in error on the order of one foot. Depending on the geometric relationship of the readers and tags, this error could be exaggerated by a large factor. As a consequence, the reader clocks should be of the type that do not exhibit more than a relatively slow drift during the interval between transmissions from the reference tag. Also, the time interval between calibration transmissions from the reference tag 41 should be as long as practically possible, in order to reduce the actual on-the-air time of the reference tag, and minimize communications load. With the current availability of micro-sized temperature ovens, and SC-cut crystals, very low clock drift rates can be achieved over a several second time frame.

As will be appreciated from the foregoing description, the cost and complexity of installing cable plant in a tagged object geolocation system are effectively obviated in accordance with the present invention, by configuring each tag reader to produce time-of-arrival (TOA) measurement data that is referenced to a local clock. This allows the data to be forwarded over a relatively low bandwidth return link (such as a readily available wireless local area network) to a location processor site. In order to compensate for the expected drift in the receiver sites' internal clocks, which would otherwise introduce error into differential time-of-arrival (DTOA)-based measurements carried out by the location processor, a reader clock offset code database is periodically updated in accordance with differential processing of time-of-arrival measurements performed by the tag readers for emissions from a fixed, known reference tag of the type employed in the system described in the '646 application.

While we have shown and described an embodiment in accordance with the present invention, it is to be understood that the same is not limited thereto but is susceptible to numerous changes and modifications as known to a person skilled in the art, and we therefore do not wish to be limited to the details shown and described herein, but intend to cover all such changes and modifications as are obvious to one of ordinary skill in the art.

What is claimed:

1. A method of geolocating objects having signal transmitting tags coupled thereto, said method comprising the steps of:
(a) at a plurality of spaced apart monitoring locations containing tag transmission readers, detecting a transmission from a tag and generating output signals representative of times of arrival of said transmission at respective ones of said tag transmission readers, in accordance with local clock signals generated at said spaced apart monitoring locations;
(b) transmitting said output signals to an object location processor which is operative to process said output signals from said tag transmission readers to geolocate said tags and thereby their associated objects within said monitored environment; and
(c) adjusting said output signals, as necessary, to compensate for variations in said local clock signals generated at said spaced apart monitoring locations, and thereby enable said object location processor to accurately process said output signals from said tag transmission readers and geolocate said tags and thereby their associated objects within said monitored environment.

2. A method according to claim 1, wherein step (c) includes storing a plurality of clock adjustment values respectively associated with said local clock signals generated at said spaced apart monitoring locations, and using said clock adjustment values to adjust said output signals and thereby enable said object location processor to accurately process said output signals from said tag transmission readers and geolocate said tags and thereby their associated objects within said monitored environment.

3. A method according to claim 2, wherein step (c) includes iteratively adjusting said clock adjustment values, to compensate for variations in said local clock signals generated at said spaced apart monitoring locations.

4. A method according to claim 3, wherein step (c) includes the steps of:
(c1) providing within said monitored environment a ‘reference’ tag whose geolocation is known, and which is operative to transmit a reference tag signal encoded with information representative of the identification of said reference tag;
(c2) receiving said reference tag signal at said transmission readers, and coupling output signals therefrom to said object location processor for processing thereby to determine the geolocation of said reference tag; (c3) comparing the geolocation of said reference tag as determined in step (c2) with the known geolocation of said reference tag; and
(c4) controllably adjusting said clock adjustment values, in accordance with a difference between the geolocation of said reference tag as determined in step (c3) and the known geolocation of said reference tag.

5. A method according to claim 1, wherein said object location processor is operative to conduct time-of-arrival differentiation processing of said output signals from said tag transmission readers to geolocate said tags.

6. A method according to claim 1, wherein step (b) comprises wirelessly transmitting said output signals to said object location processor.

7. A method according to claim 4, wherein said ‘reference’ tag is operative to repetitively transmit said reference tag signal, and wherein step (c4) comprises adjusting said clock adjustment values, as necessary, in accordance with differences between the geolocation of said reference tag as repetitively determined in step (c3) and the known geolocation of said reference tag.

8. An arrangement for geolocating objects having signal transmitting tags within a monitored environment comprising:
a plurality of spaced apart tag transmission readers which are operative to detect a transmission from a tag and to generate output signals in accordance with clock signals generated by local clock signal generators respectively associated therewith; and
an object location processor which processes said output signals generated by said tag transmission readers to geolocate said tags and thereby their associated objects within said monitored environment, said object location processor being operative to adjust said output signals, as necessary, to compensate for variations in said local clock signals generated at said spaced apart monitoring locations, and thereby accurately process said output signals from said tag transmission readers and geolocate said tags and thereby their associated objects within said monitored environment.

9. An arrangement according to claim 8, wherein said object location processor is configured to store a plurality of clock adjustment values respectively associated with said local clock signal generators at said spaced apart monitoring locations, and to adjust said output signals in accordance with said clock adjustment values to values that enable accurately processing said output signals from said tag transmission readers and thereby geolocation of said tags and their associated objects within said monitored environment.

10. An arrangement according to claim 9, wherein said object location processor is operative to iteratively adjust said clock adjustment values to compensate for variations in said local clock signals generated at said spaced apart monitoring locations.

11. An arrangement according to claim 9, further including
a ‘reference’ tag disposed within said monitored environment and whose geolocation is known, and being operative to transmit a reference tag signal encoded with information representative of the identification of said reference tag, said reference tag signal being received at said transmission readers, output signals generated by which are coupled to said object location processor for processing thereby to determine the geolocation of said reference tag; and wherein
said object location processor includes a calibration mechanism which compares the determined geolocation of said reference tag with the known geolocation of said reference tag, and controllably adjusts said clock adjustment values to compensate for variations in said local clock signal generators, in accordance with a difference between the determined geolocation of said reference tag and the known geolocation of said reference tag.

12. An arrangement according to claim 11, wherein said ‘reference’ tag is operative to repetitively transmit said reference tag signal, and said object location processor is operative to adjust said clock adjustment values, as necessary, in accordance with differences between repetitively determined locations of said reference tag and the known geolocation of said reference tag.

13. An arrangement according to claim 8, wherein said object location processor is operative to conduct time-of-arrival differentiation processing of said output signals from said tag transmission readers to geolocate said tags.

14. An arrangement according to claim 8, wherein said tag transmission readers are configured to wirelessly transmit said output signals to said object location processor.

15. A system for geolocating objects having signal transmitting tags within a monitored environment comprising:
a plurality of tag transmission readers, a respective one of which is operative to detect a first-to-arrive tag transmission, and to generate an output signal representative of the time-of-arrival of said first-to-arrive tag transmission in accordance with a clock signal generated by a local clock generator; an object geolocation processor to which output signals generated by said plurality of tag transmission readers are wirelessly coupled, and being operative to process said output signals generated by said tag transmission readers to geolocate said tags and thereby their associated objects within said monitored environment; and
a ‘reference’ tag disposed within said monitored environment and whose geolocation is known, and being operative to transmit a reference tag signal, said reference tag signal being received at said transmission readers, output signals generated by which are coupled to said object location processor for processing thereby to determine the geolocation of said reference tag; and wherein
said object location processor is operative to generate a calibration mechanism which compares the determined geolocation of said reference tag with the known geolocation of said reference tag, and controllably compensates for variations in said local clock signal generators, in accordance with a difference between the determined geolocation of said reference tag and the known geolocation of said reference tag.

16. A system according to claim 15, wherein said object location processor is configured to store a plurality of clock adjustment values respectively associated with local clock signals generated by local clock generators at said spaced apart monitoring locations, and to adjust said clock adjustment values, as necessary, in accordance with said difference between the determined geolocation of said reference tag and the known geolocation of said reference tag.

17. A system according to claim 16, wherein said ‘reference’ tag is operative to repetitively transmit said reference tag signal, and said object location processor is operative to adjust said clock adjustment values, as necessary, in accordance with differences between repetitively determined locations of said reference tag and the known geolocation of said reference tag.
